(19) United States
(12) Patent Application Publication
(10) Pub. No.: US 2007/0147963 A1
(43) Pub. Date: Jun. 28, 2007

(54) Transition Metal Nitride Coated File

(75) Inventors: James M. Critelli, Fuquay-Varina, NC (US); Jonathan S. Beckwith, Raleigh, NC (US)

Correspondence Address: COATS & BENNETT, PLLC, 1400 Crescent Green, Suite 300, Cary, NC, 27518, US

(73) Assignee: COOPER BRANDS, INC., Houston, TX (US)

(21) Appl. No.: 11/614,295

(22) Filed: Dec. 21, 2006

Related U.S. Application Data
(60) Provisional application No. 60/753,926, filed on Dec. 23, 2005.

(51) Int. Cl. B23D 71/00

(52) U.S. Cl. 407/29.1

(57) ABSTRACT

A hand operated file is provided with a thin ceramic coating of a transition metal nitride, such as vanadium nitride and/or zirconium nitride, on its teeth. The coating may be 20 um or less, thereby not altering the macro dimensions of the file. The coating may be applied using a vapor deposition process such as physical vapor deposition, and advantageously via a physical vapor deposition process where the file body does not exceed a temperature of about 300° F. The coating helps prevent galling, thereby increasing the useful life of the file.

This application claims the benefit of U.S. Provisional Application No. 60/753,926, filed Dec. 23, 2005.

### BACKGROUND OF THE INVENTION

The present invention is directed generally to hand tools known as files, and more particularly to files with transition metal nitride coatings.

Files are used for a variety of material removal applications and typically include a plurality of teeth disposed in an array on a surface that may be planar or curved. The toothed surface is placed in contact with the workpiece and then manually moved relative thereto in order to remove material from the workpiece. Typically, the file is moved manually back and forth along the workpiece, but sometimes the file is moved in only one direction when in contact with the workpiece.

When used with metallic workpieces, workpiece material may collect in the gullets that form the file's teeth. If the material is very loosely held in the gullet, then a simple shaking of the file or blowing air on the file will typically clean out the gullet. However, some of the material collected holds more tenaciously to the file. This is believed to be due to a phenomenon known as galling in the art. Galling often results when two materials slide against each other in dry contact. The softer material (from the workpiece) adheres locally to the opposite surface (the file's face), forming hard galls. The presence of these galls have a detrimental effect on file performance.

### SUMMARY OF THE INVENTION

In one embodiment, the present invention provides a method of forming a file, comprising: forming a file body having a surface and a tang extending from the file body; forming a plurality of teeth on the surface; applying a coating to the teeth via a physical vapor deposition process, the coating comprising at least a material selected from the group consisting of vanadium nitride and zirconium nitride. The coating may have a thickness of about 20 microns or less, advantageously a thickness of about 5 microns or less. The physical vapor deposition process may be such that the file body does not exceed a temperature about 300° F. during the physical vapor deposition process. A handle may be attached to the tang.

In another embodiment, the present invention provides a file, comprising: a file body having a plurality of file teeth formed thereon; a tang extending from the file body; a coating on the teeth, the coating comprising at least a material selected from the group consisting of vanadium nitride and zirconium nitride. The coating may have a thickness of about 20 microns or less, advantageously about 5 microns or less. The coating may comprise a physical vapor deposition applied vanadium nitride coating, which may cover substantially all of the file body. The file body may have any cross-sectional shape known in the art, such as a generally rectangular cross-sectional shape. A handle may be removably attached to the tang.

### BRIEF DESCRIPTION OF THE DRAWINGS

FIG. 1 shows one embodiment of a file in accordance with the present invention.

FIG. 2 shows a partial cross-section of the file of FIG. 1, taken along line II-II.

FIG. 3 shows a detail from FIG. 2 of some teeth with the coating thereon, with the coating thickness exaggerated for illustrative purposes.

### DETAILED DESCRIPTION OF THE INVENTION

The file of the present invention employs a very thin transition metal nitride coating on its working surface(s). This coating is believed to reduce galling, particularly with steel workpieces, thereby increasing the efficiency and useful life of the file.

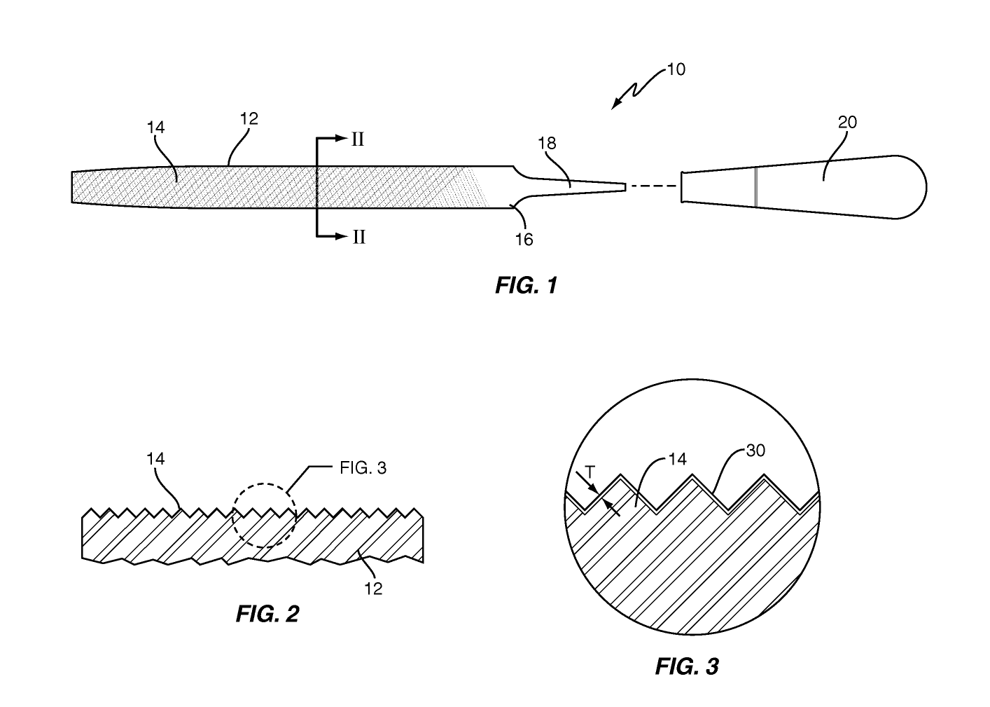

One embodiment of the file is shown in FIG. 1, and generally indicated at 10. The file includes a main section 12, a base 16, and a tang 18. The main section 12 is elongate and generally straight. The main section 12 typically has generally rectangular cross-sectional shape, see FIG. 2, but may have any shape known in the art. The file's teeth 14 are disposed in main section 12, and typically substantially cover the main section 12. The teeth 14 may be randomly arranged, but more typically are arranged in an array. The teeth 14 may take any form known in the art, and may be of any coarseness known in the art. The sides of the main section 12 may also include teeth 14, or they may be smooth. The base or heel section 16 provides a transition from the main section 12 to the rearwardly extending tang 18. The base section 16 typically does not include teeth 14, although it may include teeth 14 in some embodiments. The tang 18 typically takes the form of a relatively narrow rearwardly tapering section. The tang 18 provides a means for mating with a handle 20, which may be permanently or removably attached.

The main metal substrate portion of file 10 is typically formed of hardened steel, using any technique known in the art. For example, file steel may be cut to proper length and then rough shaped into a blank having the desired overall form (e.g., rectangular, triangular, half round, etc.). The blank may be annealed and then subjected to final shaping, including drawfiling, to produce the surface necessary for proper formation of teeth 14. The teeth 14 are then formed, typically by a rapidly reciprocating chisel that cuts into the relatively softer blank, displacing and raising the steel into the desired tooth structure. The toothed blank is then subjected to heat treatment/quenching to increase hardness. The resulting product then cleaned in a conventional fashion, and the tang 18 hardened. An optional rust inhibitor may then be applied, such as “Rust Veto 4221” available from Houghton International, Inc. of Valley Forge, Pa. To this point, the file manufacturing process is conventional.

The files 10 of the present invention include a surface coating 30 that coats at least the toothed portion of the file's main section 12. The coating 30 is a ceramic material formed as a transition metal nitride. Examples include titanium nitride (TiN), zirconium nitride (ZrN), and vanadium nitride (VN). The coating 30 may be applied using a thin film coating technique, such as physical vapor deposition (PVD). In PVD, a highly ionized plasma of the desired material is generated around the substrate (here, the base file) in a vacuum chamber. The plasma condenses on the available surfaces, forming a thin coating 30. This coating 30 has significantly increased hardness relative to the base file material (steel), has lower friction, and increased durability. However, the coating 30 is kept very thin, such as to a thickness T of about five to twenty microns or less, so as to not alter the macro physical dimensions of the file 10.

In preferred embodiments, the coating 30 is vanadium nitride deposited by a PVD process that keeps the temperature of the main body 12 below approximately 300° F. This temperature constraint helps ensure that the material properties (e.g., hardness) of the underlying steel, set during the base file formation process, are retained. One source for such a low temperature PVD coating process is a company known as Bodycote of Greensboro, N.C.

The coating 30 is applied after a conventional file forming process, it may be advantageous to remove any oil or other coatings present on the teeth 14 (and/or the entire file) prior to applying the transition metal nitride coating 30. Such cleaning may be achieved in any known fashion, including acid bath wash, ultrasonic cleaning, flame cleaning, etc. Further, it may be advantageous to subject the teeth to a plasma cleaning process in order to remove any native oxide layer that may be present, so as to promote better adherence of the coating 30.

The presence of the coating 30 is believed to increase the useful life of the file 10. Indeed, the useful life of the file 10 according to the present invention is believed to be increased by 15% or more. As such, the present file has a “life factor” or 1.15 or greater. A “life factor” is a comparison of the life of a file versus a conventional file of the same geometry with an identical metal substrate portion, using a standard test procedure.

One standard test procedure comprises using a reciprocating machine to file a test block of pre-determined hardness with a pre-determined stroke rate and length, and at a pre-determined pressure. For example, common test criteria may be used for an eight inch mill cut file; an eight inch half round file; and a ten inch all round file. The common test criteria are that the test block may is a 4140 steel block uniformly hardened to 35±2 Rockwell C, with a one inch square cross section and a length of approximately seven inches; the effective stroke length is 5½ inches; the stroke rate is sixty strokes per minute; the maximum attack angle is 8°; and the pressing force is thirty pounds. The test block is weighed before starting, and the amount of material removed (typically reported in grams) is monitored periodically. All test blocks are “run-in” using a file of the same type, but not on of the test samples. “Run-in” for flat files and for half-round files (to be tested on the half-round side) is a sufficient number of strokes to insure uniform cutting consonant with the action of the machine over the full file width. “Run-in” for the round file is to a depth on the test block equal to the largest diameter of the file, while “run-in” for triangular files on the V-side test is to the height of the file. A file brush should be used to remove excessive oil before testing. The useful life of the file is reached when the amount of material removed per stroke noticeably drops off.

The present invention may, of course, be carried out in other specific ways than those herein set forth without departing from the essential characteristics of the invention. The present embodiments are, therefore, to be considered in all respects as illustrative and not restrictive, and all changes coming within the meaning and equivalency range of the appended claims are intended to be embraced therein.

What is claimed is:

1. A file hand tool, comprising:
a file body having a plurality of file teeth formed thereon;
a tang extending from said file body;
a coating on said teeth, said coating comprising at least a material selected from the group consisting of vanadium nitride and zirconium nitride.

2. The file of claim 1 wherein said coating has a thickness of about 20 microns or less.

3. The file of claim 2 wherein said coating has a thickness of about 5 microns or less.

4. The file of claim 1 wherein said coating comprises physical vapor deposition applied vanadium nitride coating.

5. The file of claim 1 wherein said coating covers substantially all of said file body.

6. The file of claim 1 wherein said file body has a generally rectangular cross-sectional shape.

7. The file of claim 1 further comprising a handle removably attached to said tang.

8. A method of forming a file hand tool, comprising:
forming a file body having a surface and a tang extending from said file body;
forming a plurality of teeth on said surface;
applying a coating to said teeth via a physical vapor deposition process, said coating comprising at least a material selected from the group consisting of vanadium nitride and zirconium nitride.

9. The method of claim 8 wherein said coating has a thickness of about 20 microns or less.

10. The method of claim 9 wherein said coating has a thickness of about 5 microns or less.

11. The method of claim 8 wherein said applying said coating comprises applying said coating to said teeth via a physical vapor deposition process such that said file body does not exceed a temperature of about 300° F. during said physical vapor deposition process.

12. The method of claim 8 further comprising attaching a handle to said tang.
